(19) United States
(12) Patent Application Publication
(10) Pub. No.: US 2003/0056115 A1
(43) Pub. Date: Mar. 20, 2003

(54) System for and method of protecting data in firmware modules of embedded systems

(76) Inventor: Andreas Falkenberg, San Diego, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/957,204

(22) Filed: Sep. 20, 2001

(51) Int. Cl. G06F 12/14

(52) U.S. Cl. 713/201

(57) ABSTRACT

The privacy of data in firmware modules of embedded systems can be obtained by a method and system that restrict access to local variables even where there are limited (or no) restrictions imposed by the program assembler. The technique used by the method and system can use a private data section, having data to be protected, and a public code section, allowing controlled access to data in the private data section. Access to functions in the public code section is allowed to external code. In contrast, data in the private data section is protected and cannot be accessed directly. The only access to such data is provided by public functions defined in a code section.

### BACKGROUND OF THE INVENTION

The present invention relates generally to embedded systems and computer programs to access such systems. More particularly, an exemplary embodiment of the present invention relates to a system for and a method of protecting data in firmware modules of embedded systems.

A problem with implementing firmware for embedded systems is that there is no certain mechanism to protect the internal data. Without a protective mechanism, there is open access to all kinds of internal data. Programmers have little or no mechanism to protect data from access by external program code.

Restrictions on access to data may be present in high level computer programming languages, such as C or C++. Nevertheless, firmware for embedded systems generally uses assembly or other types of lower level programming languages that do not have such restrictions in the programming nor the assembler that processes the programming.

Thus, there is a need to provide protection and privacy of data in local procedures. Further, there is a need to permit external access only through dedicated functions controlled by the module itself. Even further, there is a need to protect data in firmware modules of embedded systems.

### SUMMARY OF THE INVENTION

The present invention relates to the privacy of data in firmware modules of embedded systems. This privacy is obtained by a method and system that restrict access to local variables even where there are limited (or no) restrictions imposed by the program assembler. The technique used by the method and system can include using a private data section, having data to be protected, and a public code section, allowing controlled access to data in the private data section. Access to functions in the public code section is allowed to external code. In contrast, data in the private data section is protected and cannot be accessed directly. The only access to such data is provided by public functions defined in a code section.

An exemplary embodiment of the invention is related to a method of protecting data in firmware modules of embedded systems from external access. This method can include establishing a private data section and a public code section in firmware and providing access to data contained in the private data section via the public code section to external functions. The public code section is configured to provide controlled access to data contained in the private data section by external functions.

Another exemplary embodiment of the invention is related to a system that protects data in firmware modules of embedded systems. The system can include a private data section in firmware that maintains data and a public code section in firmware that includes dedicated functions which allow limited access to data contained in the private data section by external functions.

An exemplary embodiment of the invention is related to a processing system including a central processing unit (CPU) and a storage device coupled to a processor and having stored there information for configuring the CPU. The CPU can be configured to store data in a private data section of firmware and permit access to stored data in the private data section by functions defined in a public code section of firmware.

Other principle features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals denote like elements, and:

FIG. 1 is a block diagram representation of a system for protecting data in firmware modules of embedded systems in accordance with an exemplary embodiment;

FIG. 2 is a block diagram representation of a mobile communication apparatus including protection of data in firmware modules in accordance with another exemplary embodiment; and

FIG. 3 is a flow diagram depicting exemplary steps in a method of protecting data in firmware modules of embedded systems in accordance with yet another exemplary embodiment.

### DETAILED DESCRIPTION OF THE EXEMPLARY EMBODIMENTS

A system for and method of protecting data in firmware modules of embedded systems are described. In the following description, for purposes of explanation, numerous specific details are set forth in order to provide a thorough understanding of the present invention. It will be evident, however, to one skilled in the art that the exemplary embodiments may be practiced without these specific details. In other instances, structures and devices are shown in block diagram form in order to facilitate description of the exemplary embodiments.

In one embodiment, a computer system can be used which has a processor or a central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

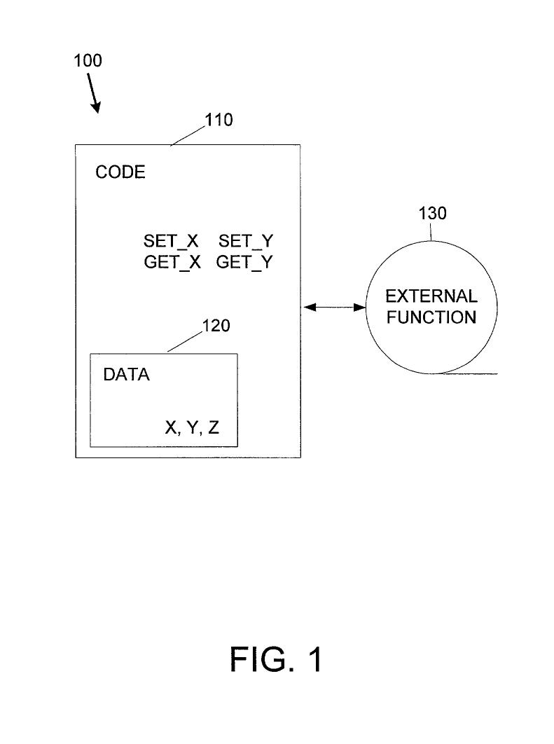

FIG. 1 illustrates a system 100 that is configured for protecting data in firmware modules of embedded systems. System 100 can include a code section 110 and a data section 120. Code section 110 includes dedicated functions, such as, GET_X and GET_Y that coordinate operation with an external function 130. External function 130 can be a portion of another computer program that accesses code section 110 by a network. External function 130 can also be part of the application that executes or runs code section 110.

Data section 120 is embedded within code section 110 and is private in that direct access to data section 120 is limited to code section 110. External function 130, for example, cannot directly access data section 120, but can obtain data from data section 120 via code section 110.

Accordingly, in operation, external function 130 can communicate to and from code section 110. However, in order to obtain data stored within data section 120, external function 130 must execute dedicated functions in code section 110. As such, data in firmware modules of embedded systems can be protected from unintended use.

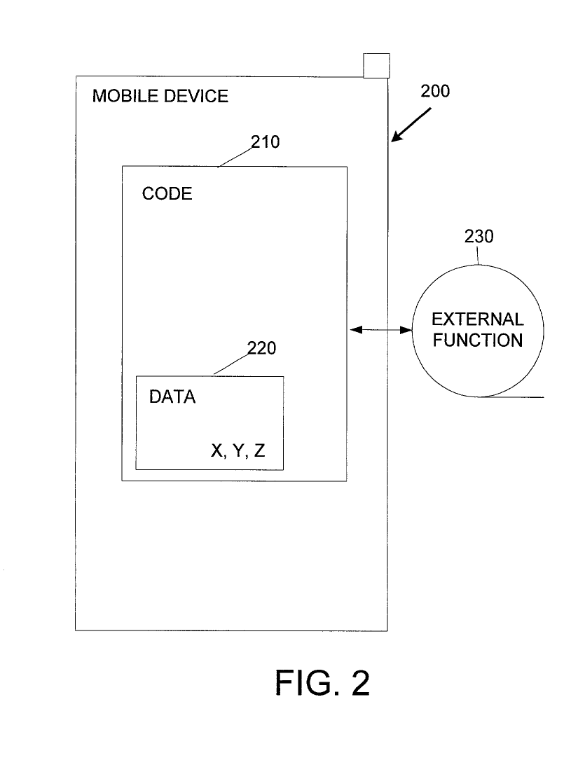

FIG. 2 illustrates a mobile communication apparatus 200 that includes protection of data in firmware modules. Apparatus 200 can include a public code section 210 and a limited data access data section 220. Apparatus 200 can be a cellular phone, computer, or any other mobile device configured for communication with other computing devices.

Public code section 210 can include functions that coordinate operation with an external function 230. External function 230 can be a portion of another computer program that accesses code section 210 by a network or some other communication means. External function 230 can be part of the application that executes or runs public code section 210.

Advantageously, limiting direct access of limited data access section 220 to functions in code section 210 provides security in that access of data must be done in a defined manner. For example, where a digital signal processor (DSP) is used in mobile device 200, critical data can be included in limited data access section 220 such that data can be retrieved (or what ever function is defined in public code section 210) but cannot be manipulated (or used in a manner not defined in code section 210).

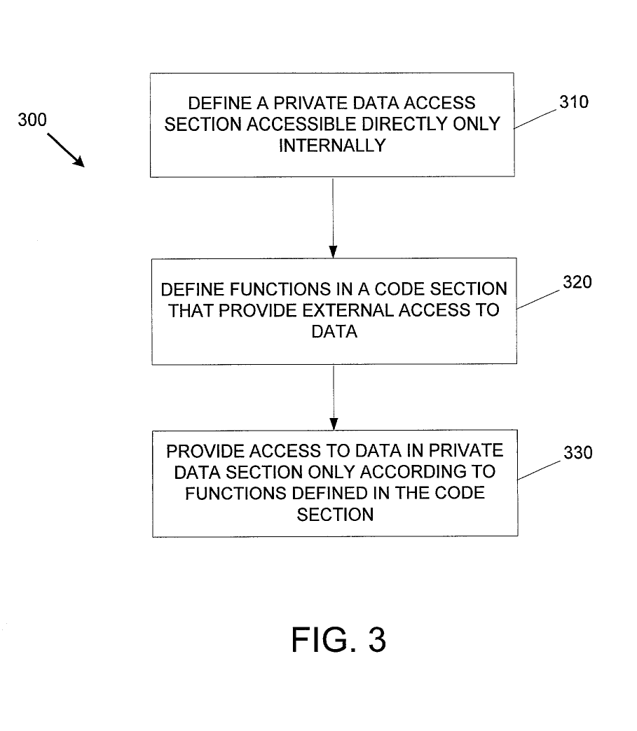

FIG. 3 illustrates a flow diagram 300 depicting exemplary steps in a method of protecting data in firmware modules of embedded systems. In a step 310, data is protected within a defined private data section that can only be accessed directly by internal procedures and functions. In a step 320, functions are established in a public code section that provide limited access to data contained in the private data section. In a step 330, access to data in the private data section is provided only according to functions defined in the code section.

Exemplary computer code segments are provided below for illustration purposes. A general template to provide protected data can include the following:

.PUBLIC Module_Name_Code.Function1

.PUBLIC Module_Name_Code.Function2

.DATA Module_Name_Data

Data1: DW?

Data2: DW?

.CODE Module_Name_Code

Function1:

. . .

Function 2:

. . .

In this general template code, the module handling the protected data is called Module_Name. In this module there are two sections, a DATA section called Module_Name_Data and a CODE section called Module_Name_Code. The data specified in the DATA section is protected since the only external access is via the functions defined in the CODE section.

A more specific example of protecting data in the firmware of embedded systems can include the following:

| | |
|---|---|
| .PUBLIC Date.Get_Day | ;Public Functions |
| .PUBLIC Date.Set_Year | |
| .DATA Date_Data | ;Data Section is local or protected |
| Month: DW? | |
| Day: DW? | |
| Year: DW? | |
| .CODE Date_Code | ;Code Section |
| Get_Day: | ;Access to Data Section only via a |
| | public function |
| pop rb | ;save return address |
| mov Date_Data.Day, r3 | ;get Day from Data section |
| push r3 | ;put it on stack |
| push rb | ;return address on stack |
| ret | ;return from routine |
| Set_Year: | |
| pop rb | |
| pop r3 | |
| ....... | |

Since external access is only possible via external functions and the internal data is protected, access can be provided in the way shown in the following example:

| | |
|---|---|
| .EXTERN Date_Code.Get_Day | ;all used functions are |
| | external |
| .EXTERN Date_Code.Set_Year | ; |
| push #2001 | |
| call Date_Code.Set_Year | |
| call Date_Code.Get_Day | |
| pop r4 | ;the day is in r4 |

The EXTERN definition shows that there are some declared functions, which can be called from this point, because they are public. Now a call can be done to this set of functions. The example leads to the following general template:

.EXTERN Module_Name_Code.Function1

.EXTERN Module_Name_Code.Function2

. . .

call Module_Name_Code.Function1

call Module_Name_Code.Function2

. . .

Advantageously, the system and method described with reference to the FIGURES includes encapsulation in that modules encapsulate internal data. Further, certain data that is important for the proper functionality of the system, can only be accessed in an orderly way. Indeed, data can be accessed only in the intended way, as defined by the dedicated functions of the code section, even if the data is not important for the proper functionality of the system.

While the exemplary embodiments illustrated in the figures and described above are presently preferred, it should be understood that these embodiments are offered by way of example only. Other embodiments may include, for example, different variations of programming code. The invention is not limited to a particular embodiment, but extends to various modifications, combinations, and permutations that nevertheless fall within the scope and spirit of the appended claims.

What is claimed is:

1. A method of protecting data in firmware modules of embedded systems from external access, the method comprising:
establishing a private data section and a public code section in firmware, the public code section being configured to provide controlled access to data contained in the private data section by external functions; and
providing access to data contained in the private data section via the public code section to external functions.

2. The method of claim 1, wherein the private data section and public code section are established in an assembly programming language.

3. The method of claim 2, wherein providing access to data contained in the private data section via the public code section to external functions includes establishing functions that allow external functions to have limited access to data contained in the private data section.

4. The method of claim 3, wherein the functions established to allow external functions access to data contained in the private data section cannot be changed by the external functions.

5. The method of claim 4, wherein the private data section and public code section established in firmware are included in a digital signal processor (DSP).

6. The method of claim 5, wherein the digital signal processor (DSP) is associated with a communication device.

7. A system that protects data in firmware modules of embedded systems, the system comprising:
a private data section in firmware that maintains data; and
a public code section in firmware that includes dedicated functions which allow limited access to data contained in the private data section by external functions.

8. The system of claim 7, wherein the private data section and the public code section are included in a digital signal processor (DSP).

9. The system of claim 8, wherein the digital signal processor (DSP) is included in communication device.

10. The system of claim 7, wherein the dedicated functions include a get function.

11. A processing system comprising:
a central processing unit (CPU); and
a storage device coupled to a processor and having stored there information for configuring the CPU to:
store data in a private data section of firmware; and
permit access to stored data in the private data section by functions defined in a public code section of firmware.

12. The system of claim 11, wherein the private data section and public code section are written in an assembly programming language.

13. The system of claim 12, wherein permitting access to stored data in the private data section by functions defined in a public code section of firmware includes establishing functions that allow external functions to have limited access to data contained in the private data section.

14. The system of claim 13, wherein the functions established to allow external functions access to data contained in the private data section cannot be changed by the external functions.

15. The system of claim 14, wherein the private data section and public code section established in firmware are included in a digital signal processor (DSP).

16. The system of claim 15, wherein the digital signal processor (DSP) is associated with a communication device.
